(19) United States
(12) Patent Application Publication
(10) Pub. No.: US 2024/0375085 A1
(43) Pub. Date: Nov. 14, 2024

(54) ELECTROCHEMICAL REGENERATION METHOD OF ACTIVATED CARBON

(71) Applicant: Chongqing University, Chongqing (CN)

(72) Inventors: Chun ZHAO, Chongqing (CN); Jian ZHANG, Chongqing (CN); Wenli LI, Chongqing (CN); Shuaishuai YANG, Chongqing (CN); Mingyang ZHANG, Chongqing (CN); Chao MA, Chongqing (CN); Ziheng SONG, Chongqing (CN)

(21) Appl. No.: 18/540,180

(22) Filed: Dec. 14, 2023

(30) Foreign Application Priority Data
May 12, 2023 (CN) 202310535757.X

(51) Int. Cl. B01J 20/34; B01D 15/20; B01J 20/20; B01J 20/28

(52) U.S. Cl. CPC B01J 20/3475; B01D 15/203; B01J 20/20; B01J 20/28023; B01J 20/3416; B01J 20/3441

(57) ABSTRACT

The present disclosure discloses an electrochemical regeneration method of activated carbon, including the following steps of placing activated carbon saturated with an organic compound into an electrolysis system containing a regeneration solution to serve as a cathode of the electrolysis system, adding a peroxide I and a peroxide II to the regeneration solution, connecting to power and conducting a reaction, and after the reaction is completed, taking out and drying the activated carbon to obtain regenerated activated carbon, where the peroxide I is a persulfate. The present disclosure is easy to operate and requires no addition of a metal ion. Many technologies are used and cooperated with each other to produce oxidative and reductive active species synchronously, thereby achieving efficient degradation and mineralization of refractory organic pollutants.

### CROSS REFERENCE TO RELATED APPLICATION

This patent application claims the benefit and priority of Chinese Patent Application No. 202310535757.X, filed with the China National Intellectual Property Administration on May 12, 2023, the disclosure of which is incorporated by reference herein in its entirety as part of the present application.

### TECHNICAL FIELD

The present disclosure belongs to the technical field of adsorbent in-situ regeneration, and in particular to an electrochemical regeneration method of activated carbon with saturated adsorption of an organic compound.

### BACKGROUND

As a widely-used high-efficiency adsorbent material, activated carbon has a large number of pore structures on its surface and has a larger specific surface area and thus can adsorb small molecules more quickly. With the advantages such as a stable structure, a higher adsorption capacity and easy regeneration, the activated carbon has been widely applied in the fields such as chemical engineering, medicine and environmental protection. The application in environmental protection mainly includes organic-pollutant water treatment, industrial wastewater treatment, and water pollution emergency treatment. Particularly, the activated carbon has been extensively applied to industrial wastewater, including the treatment processes of polluted water such as phenolic wastewater and pharmaceutical wastewater. However, activated carbon will be up to a state of saturated adsorption after treating organic wastewater for a period of time, resulting in the failure of adsorbing organic pollutants any more. If activated carbon is discarded directly, it causes waste of resources, environmental pollution and increased operation cost. Therefore, it needs to regenerate the activated carbon with saturated adsorption, thereby recovering its adsorption performance and being recycled.

Currently; regeneration methods commonly used in industry are thermal regeneration, ultrasonic regeneration, microwave regeneration, bioregeneration, and chemical regeneration. The thermal regeneration includes four stages of drying, evaporation, pyrolysis, and activization. From the angle of regeneration process, high temperature will make the surface structure of activated carbon changed, which will damage the surface performance of an adsorbent. As a result, there exists thermal losses of the adsorbent, and after repeated regeneration, the capability of adsorption is lost for activated carbon. For example, CN101987275B has provided a method and a device for recycling volatile organic compounds (VOCs) by adsorption-electrothermal desorption: the device is charged with electricity and heated such that an adsorption cylinder of an adsorbent is heated up via the activated carbon fiber; moreover, an inert gas is introduced to make VOCs adsorbed on the wall of the cylinder wall desorbed, thereby achieving the regeneration of the device. To increase the temperature of the desorption process is a direct means to enhance the operating efficiency for the thermal desorption regeneration technology. However, the method is only suitable for the in-situ regeneration of activated carbon adsorbing VOCs, and has little effect on the regeneration of activated carbon adsorbing organic compounds with a high boiling point.

Electrochemical regeneration can enable pollutants to be desorbed from activated carbon by means of local pH changes and electrostatic repulsion, and serves as an efficient desorption and regeneration method of activated carbon. However, the method cannot be used to degrade and mineralize the pollutants desorbed thoroughly, but accumulate them into a regeneration solution at the same time. Therefore, the method may cause serious ecological hazard. Moreover, with the increase of regeneration time, higher toxicity may be caused. CN103435132A has disclosed an activated carbon fiber treating oily wastewater, a regeneration method, and a device for application of the method; according to the method, an activated carbon fiber felt wrapped on a Ti-based metallic oxide serves as an anode, and pure titanium serves as a cathode to process oily wastewater. The removal ratio of the target pollutant and regeneration effect of the oily wastewater can be up to 95% and 97%, respectively, but electrochemical oxidation only occurs on the surface of the anode and thus, is limited to its mass transfer capacity, leading to limited mineralization ability and producing toxic intermediates. Moreover, the occurrence of electrochemical oxidation requires a higher voltage, which causes higher energy consumption, serious electrode dissipation and is against popularization and application. To improve the oxidation capacity of electrochemical regeneration, electrolyte solutions such as sodium chloride and hydrochloric acid can be used: the ability to decompose and oxidize pollutants is enhanced by electrolysates including strong oxidizing substances such as chlorine, hypochlorous acid, and hydroxyl radicals. For example, CN107055670A has disclosed an adsorption-electrochemical regeneration method of activated carbon treating degradation-resistant organic wastewater; air is fed during electrolysis, oxygen will be reduced to H₂O₂ on the cathode, and then further transformed into hydroxyl radical via a catalyst Mn or Fe on the activated carbon, thereby improving the oxidative degradation efficiency of organic compounds. Even though the formed 3D electrode has a better regeneration effect on the activated carbon adsorbing concentrated water from low-pressure nanofiltration (DF) after biological treatment process, limited to the yield of H₂O₂, the amount of the hydroxyl radical produced is limited; therefore, it is hard to thoroughly mineralize the pollutants. Moreover, the method is only suitable for the activated carbon loaded with a small amount of Fe and Mn, and has no effect on the activated carbon without a catalyst like Mn or Fc.

Advanced oxidation technology alone brings a satisfactory degradation effect on organic pollutants, but it is difficult to prevent the structure and surface properties of activated carbon from oxidative damage. Further, the advanced oxidation technology can be used with other technologies to reduce the damage on the structure of activated carbon. For example, CN113680340A has disclosed a low temperature heat-liquid phase in situ regeneration method of activated carbon powder based on a coupling effect of continuous variable-frequency ultrasonic wave/ozone solution. Ozone is accelerated to conduct migration and mass transfer in the activated carbon pores via the continuous variable-frequency ultrasonic wave, which reduces the ozone destruction effect on the structure of activated carbon and achieves the effective regeneration of activated carbon. However, as the continuous variable-frequency ultrasonic technology demands for high construction and operating costs, popularization and application of the method are confined. In the existing advanced oxidation technologies, intermediate products with higher biotoxicity may be produced during the oxidization of some special pollutants (halogenated organic compounds). Dehalogenation can be carried out very well by reductive free radicals (e.g., e_{aq}⁻, SO₃⁻, H, and O₂⁻) generated by advanced reduction processes, thus decreases ecotoxicity in a regeneration solution. However, oxygen needs to be isolated in the reaction processes, which greatly limits the range of application.

### SUMMARY

With regard to the shortcomings in the prior art, the objective of the present disclosure is to provide an electrochemical regeneration method of activated carbon. The method can help solve the prior-art problems of difficulty in achieving regeneration of activated carbon and pollutant degradation and mineralization simultaneously, poor regeneration efficiency repeatability of activated carbon, limited pollutant degradation and mineralization ability; easy-to-damage structure and surface properties of activated carbon during regeneration, high energy consumption, higher costs, and limited range of applications.

To solve the above technical problems, the technical solution adopted by the present disclosure is as follows:

An electrochemical regeneration method of activated carbon includes: placing organic saturated activated carbon into an electrolysis system containing a regeneration solution to serve as a cathode of the electrolysis system; adding a peroxide I and a peroxide II to the regeneration solution, where the peroxide I is a persulfate, and connecting to power and conducting a reaction, and adding the peroxide II dropwise during the reaction, and after the reaction is completed, taking out and drying the activated carbon to obtain regenerated activated carbon.

Further, the electrode system has an operating current density of 10-120 mA/cm².

Further, a mass ratio of the activated carbon, the persulfate, and the peroxide II is 1:(5-50):(5-50), preferably, 1:(10-40):(10-45).

Further, the peroxide II includes one or more selected from the group consisting of hydrogen peroxide, peracetic acid, and an alkali metal peroxide; preferably, hydrogen peroxide.

Further, the organic compound is one or more selected from the group consisting of a halogenated organic compound, phenol, an antibiotic, and an endocrine disruptor.

Further, the peroxide II is continuously added by stages at different rates during reaction. Further, the peroxide II is added faster in the first 0.5-1 h than in a remaining reaction time. As the reaction goes on, hydrogen peroxide may be blown off by a gas generated by the electrolysis; if hydrogen peroxide is added once only, the amount of hydrogen peroxide may be not sufficient for the whole reaction, thus affecting the regeneration effect of activated carbon. Moreover, the persulfate is consumed during the reaction and a relatively small amount of the persulfate is left in the reaction solution. Therefore, a relatively small amount of hydrogen peroxide is added at a relatively low rate.

Further, in the electrode system, the cathode is selected from the group consisting of a metal electrode and a composite metal electrode, and used as a supporting layer for placing the activated carbon to be regenerated: the anode is selected from the group consisting of a metal electrode, a metal oxide electrode, a graphite electrode, and a composite metal electrode.

Further, the activated carbon is selected from the group consisting of composite carbon-based/modified carbon-based materials having a better adsorption property to organic compounds, such as a powdered activated carbon, a granular activated carbon, an activated carbon fiber, a carbon felt, a carbon nano tube, and a graphene; preferably, an activated carbon fiber.

Further, the regeneration solution is water, and may include one or more electrolytes selected from the group consisting of a sulfate, a chloride salt, and a carbonate.

The persulfate-based advanced oxidation technology is to activate persulfate by means of heat, ultraviolet ray, transition metal ions, carbon materials, electricity, and alkali, thus producing various reactive oxygen species and achieving the purpose of oxidative degradation. The technology has been extensively concerned due to its strong oxidation capacity: stable treatment, and zero secondary pollution. In the present disclosure, electrochemistry is used with peroxides to regenerate the saturated activated carbon. The present disclosure may enable organic pollutants to be desorbed quickly into the regeneration solution under the action of an electric field, an alkaline diffusion layer formed near cathode by electrolysis of water and hydrogen peroxide. Moreover, the present disclosure further produces active species continuously via the activation of the peroxides with the electric field, thereby degrading and mineralizing the pollutants. In addition, activated carbon is placed into and serves as the cathode of an electrochemical regeneration system, which may make the activated carbon free of oxidative damage caused by oxidizing agents and active substances. Therefore, the structural integrity and properties of activated carbon are not seriously affected. Therefore, persulfate and hydrogen peroxide are combined with electrolysis to conduct an in-situ regeneration reaction on activated carbon as cathode, which recovers the adsorption capacity of activated carbon in situ, degrade and mineralize the pollutants adsorbed, simultaneously. Therefore, the present disclosure may achieve recycling, reduce operating costs, and solve the problems such as waste of resources and environmental pollution caused by waste activated carbon. Moreover, the method may recover the adsorption capacity of activated carbon, thoroughly degrade and mineralize organic compounds in the regeneration solution; and the product is carbon dioxide, water, and inorganic ions, eco-friendly and pollution-free.

In the present disclosure, the regeneration principle of the electrochemical/persulfate/hydrogen peroxide method on activated carbon may be divided into the following aspects: one is electrochemical desorption brought by the change of local pH, change of local salinity concentration as well as electrostatic repulsion; two is electro-oxidation; organic compounds are degraded due to its electron transfer on the surface of the anode; three is direct oxidation of peroxide; and four is indirect oxidation and reduction; oxidative and reductive active oxygen species (including SO·₄⁻, HO·, O·₂⁻, HO₂⁻¹, O₂, and atomic hydrogen) are produced simultaneously via the synergistic effect of electrochemistry with persulfate and hydrogen peroxide, so as to achieve the efficient degradation and mineralization of refractory organic compounds.

Main reaction is as follows:

firstly, organic saturated activated carbon is placed into or as the cathode and the organic compound R is desorbed in to solution due to the electric produced OH⁻ and electric repulsion, which is expressed as:

2H₂O+e⁻→2OH⁻+H₂↑

H₂O₂+e⁻→HO·+OH⁻

ROH→RO⁻+H⁺

secondly, persulfate and hydrogen peroxide in the electrolyte are electro-activated into reactive species, which are in synergy with the oxidation and reduction of the organic compound during electrocatalysis. It is expressed as:

H₂O→HO·+H⁺+e⁻

OH⁻→HO·+e⁻

H₂O→HO·+H⁺+e⁻

SO₄²⁻→SO₄·⁻+e⁻

2HSO₅⁻+H₂O₂+e⁻→O₂·⁻+HSO₄⁻+H₂O

HSO₅⁻+H₂O→SO₄²⁻+2HO·+H⁺

SO₅·⁻+2H₂O→SO₄²⁻+3HO·+H⁺

HSO₅⁻+e⁻→SO₄·⁻+OH⁻

HSO₅⁻+e⁻→SO₄⁻+OH·

SO₄·⁻+H₂O→HSO₄⁻+OH·

HSO₅⁻+O₂·⁻→SO₄·⁻+O₂+OH⁻

SO₅²⁻+H₂O→O₂·⁻+SO₄²⁻+H⁺

S₂O₈²⁻+H₂O₂→2HO·+2SO₄·⁻+H₂O

S₂O₈²⁻+2H₂O₂→2O₂·⁻+2SO₄²⁻+H₂O

S₂O₈²⁻+HO₂⁻→SO₄·⁻+SO₄²⁻+O₂·⁻+H⁺

XO₂ (alkaline peroxide)+2H₂O→H₂O₂+X(OH)₂

ROOH(PAA)+H₂O→H₂O₂+ROH

H₂O₂+e⁻→HO·+OH⁻

H₂O₂+HO·>HO₂·+OH⁻

and thirdly, decomposition of the organic compound R:

R+SO₄·⁻(H₂O₂/XO₂/ROOH,OH·,HSO₅⁻/S₂O₈²⁻,O₂·⁻, etc.)→CO₂↑+H₂O+SO₄²⁻

A regeneration ratio is calculated by: RE (%)=Q′/Q

In the formula, Q is the adsorbing capacity (mg/g) of activated carbon in the state of saturated adsorption for the first time; Q′ is the adsorbing capacity (mg/g) of regenerated activated carbon in the state of saturated adsorption.

Compared with the prior art, the present disclosure has the following beneficial effects:

1. In the present disclosure, the electrochemical technology is combined with persulfate and hydrogen peroxide to treat organics saturated activated carbon. The present disclosure achieves the regeneration of activated carbon, degradation and mineralization of pollutants, simultaneously. Moreover, the activated carbon has good regeneration repeatability, being stabilized at least 60% of regeneration ratio after 10 recycles. Meanwhile, organic pollutants can be degraded and mineralized efficiently: the pollutant removal ratio can be at least 95% stably, and the mineralization ratio can be also up to at least 90%. Moreover, compared with electrochemical-persulfate system and a separate electrolysis system, the electrochemical/persulfate/hydrogen peroxide system has lower comprehensive energy consumption, thus lower costs. When activated carbon with same mass and adsorbing capacity is treated, comprehensive energy consumption in the present disclosure is ½ of the electrochemical-persulfate system and 1/10 of the separate electrolysis system. Moreover, organic pollutants are degraded and mineralized more efficiently.

2. The electrocatalytic double-peroxides can produce reductive and oxidative active species at the same time. Moreover, the addition of hydrogen peroxide may not only promote the formation of an alkaline diffusion layer on the cathode under the action of an electric field to achieve rapid desorption of organic compounds, but also may catalyze the persulfate to produce SO₄·⁻ much quickly. The electrocatalytic double-peroxides system has a SO₄·⁻ yield 18.2 times of the electrochemical-persulfate system. Therefore, the present disclosure can maximize the degradation and mineralization of organic compounds, and reduce the input of agents and save costs at the same time.

3. Protected by the cathode, activated carbon will not be seriously damaged by the oxidizing agent and active oxygen species during regeneration in the present disclosure, thereby solving the problem of the existing activated carbon regeneration method, namely, structure of activated carbon is damaged seriously.

### BRIEF DESCRIPTION OF THE DRAWINGS

FIG. 1 shows a time-concentration curve of phenol in a regeneration solution of Example 1;

FIG. 2 shows a time-concentration curve of total organic carbon (TOC) in the regeneration solution of Example 1:

FIG. 3 shows a time-concentration curve of perfluorooctane sulfonates (PFOS) in the regeneration solution of Example 2;

FIG. 4 shows a time-concentration curve of TOC in a regeneration solution of Example 2:

FIG. 5 shows a time-concentration curve of phenol in a regeneration solution of Example 3; and

FIG. 6 is a comparison diagram showing steady-state concentrations of an electrochemical/persulfate/hydrogen peroxide system SO₄·⁻ and an electrochemical/persulfate system.

### DETAILED DESCRIPTION OF THE EMBODIMENTS

The specific implementation of the present disclosure will be further described below in conjunction with detailed examples.

For a numerical range in the present disclosure, it should be understood that each intermediate value between an upper limit and a lower limit of the range is also specifically disclosed. Each smaller range between any stated value or intermediate value in a stated range and any other stated value or intermediate value in the stated range is also included in the present disclosure. The upper and lower limits of these smaller ranges can independently be included or excluded from the range.

Unless otherwise stated, all technical and scientific terms used herein have the same meaning as commonly understood by those of ordinary skill in the art described in the present disclosure. Although the present disclosure describes only preferred methods and materials, any methods and materials similar or equivalent to those described herein can also be used in the practice or testing of the present disclosure. All documents mentioned in this specification are incorporated by reference to disclose and describe methods and/or materials related to the documents. In case of conflict with any incorporated documents, the content of this specification shall prevail. As used herein, “including”, “having”, “containing”, and the like are all open-ended terms, which means including but not limited to.

Unless otherwise specified, the experimental methods used herein are conventional methods.

All the materials and reagents used herein may be commercially available or synthesized via a known method, unless otherwise specified.

All quantitative tests in the present disclosure are set to run in triplicate, and the results are averaged.

The concentration of phenol in the examples is determined by liquid chromatography: the concentration of PFOS is determined by LC-MS, and TOC is determined by a TOC analyzer.

Removal ratio of organic compound is calculated by the following formula (1):

$$Removal ratio of organic compound = 1 \frac{{C}_{organic compound}}{Q * \frac{m}{V}} \qquad ( 1 )$$

in the formula (1), C_{organic compound} is a concentration of the organic compound in a solution after the regeneration of activated carbon; Q is a mass of the organic compound adsorbed after per gram of activated carbon is fully saturated; m is a mass of activated carbon, and V is a regeneration solution volume.

Mineralization ratio is calculated by the following formula (2):

$$Mineralization ratio = 1 - \frac{{C}_{TOC}}{Q * \frac{m * N * 12}{V * M}} \qquad ( 2 )$$

in the formula (2), C_{TOC} is a concentration of TOC in solution after the regeneration of activated carbon; Q is a mass of the organic compound adsorbed after per gram of activated carbon is fully saturated; m is a mass of activated carbon, and V is a regeneration solution volume; N is the carbon number of organic pollutants; and M is a molecular weight of organic pollutants.

### Example 1

An electrochemical regeneration method of saturated activated carbon was provided, including the following steps:

(1) preparation of a saturated activated carbon fiber: 0.2 g of an activated carbon fiber was placed into 200 mL of 1600 mg/L phenol solution for adsorption for 24 h, and then taken out and put to a drying oven at 38° C. for 12 h, to obtain the activated carbon with saturated adsorption of phenol.

The adsorbing capacity of the activated carbon fiber was 271.96 mg/g through calculation according to the concentrations of phenol before and after adsorption, the volume of phenol solution and the mass of the activated carbon fiber before adsorption.

(2) regeneration of the saturated activated carbon fiber: the activated carbon with saturated adsorption of phenol was used as a cathode of an electrolysis system: 250 mL of a regeneration solution (water) was added to a reaction chamber of the electrolysis system, then potassium peroxymonosulfate was added to the regeneration solution such that the regeneration solution had a concentration of 18 g/L: a hydrogen peroxide solution was then added to the regeneration solution such that the hydrogen peroxide had an initial concentration of 0.4 mM/L, afterwards, a DC power supply was turned on to regenerate activated carbon at an operating current density of 28.57 mA/cm². During the regeneration. 30 wt % hydrogen peroxide solution was continuously added dropwise by stages at different rates, that is, added at a rate of 1.1 mL/h in the first 40 min and then added at a rate of 0.3 mL/h in the last 260 min. 5 h after the reaction, the activated carbon fiber was taken out and dried at 38° C. for 12 h, to obtain the regenerated activated carbon fiber.

The cathode and anode electrodes in this example were platinum coated titanium electrodes. In practical application, the cathode may be also selected from the group consisting of other metal electrodes or composite metal electrodes, and used as a supporting layer for placing the activated carbon to be regenerated. The anode may be selected from the group consisting of other metal electrodes, metal oxide electrodes, graphite electrodes, and composite metal electrodes.

The method of the present disclosure is also applicable to the regeneration of a powdered activated carbon, a granular activated carbon, an activated carbon fiber, a carbon felt, a carbon nano tube, or a graphene.

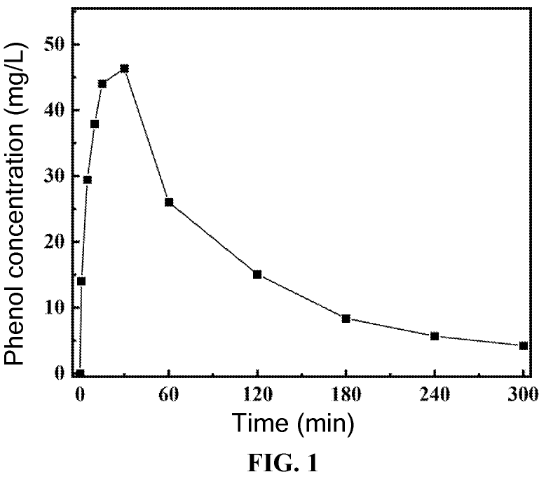

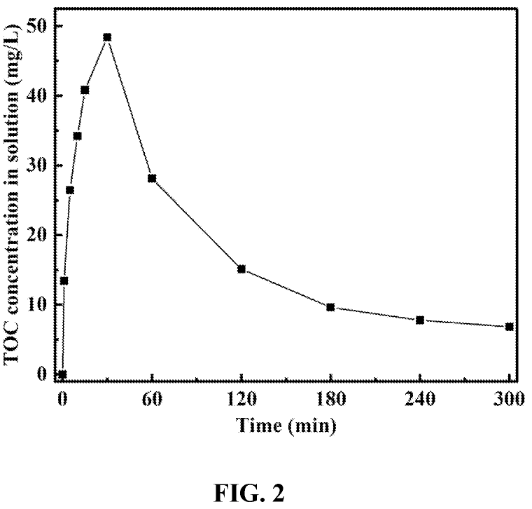

Treatment effect: the activated carbon fiber with saturated adsorption of phenol had a regeneration rate of 80.77% after being treated by the method in this example. The time-concentration curves of phenol and TOC in the regeneration solution are shown in FIGS. 1 and 2, respectively. As can be seen from FIG. 1, the phenol concentration in the solution after 5 h of regeneration is 4.22 mg/L, and the removal ratio of phenol was 98% calculated according to formula (1). As can be seen from FIG. 2, the TOC concentration in the solution after 5 h of regeneration is 6.81 mg/L in this example, and the organic compound mineralization ratio is 95% calculated according to formula (2).

### Example 2

An electrochemical regeneration method of saturated activated carbon was provided; and the main steps were the same as those in Example 1. Example 2 differed from Example 1 in that the organic compound adsorbed was PFOS and the adsorbing capacity was 98.71 mg/g.

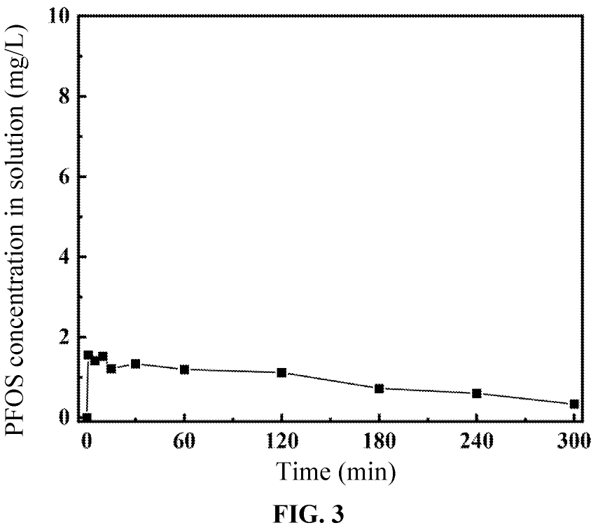

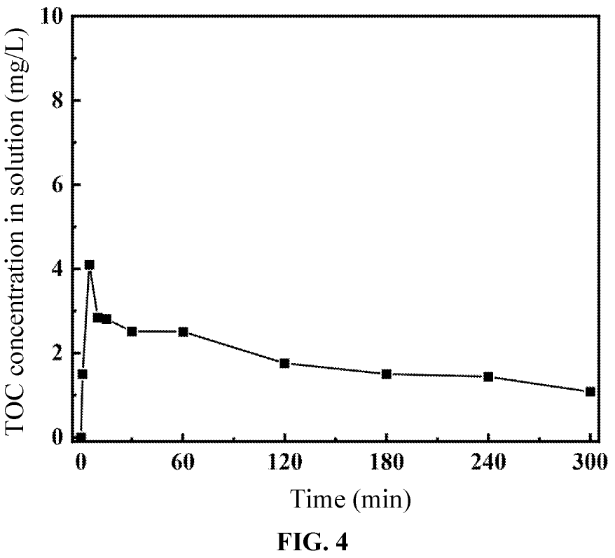

Treatment effect: the activated carbon fiber had a regeneration ratio of 95.9%. The time-concentration curves of PFOS and TOC in the regeneration solution are shown in FIGS. 3 and 4, respectively. As can be seen from FIG. 3, after 5 h of regeneration, the PFOS concentration is 0.33 mg/L, and the PFOS removal ratio is 99% calculated according to formula (1). As can be seen from FIG. 4, the TOC concentration in the solution after 5 h of regeneration is 1.08 mg/L, and the organic compound mineralization ratio is 93% calculated according to formula (2).

### Example 3

An electrochemical regeneration method of saturated activated carbon was provided; and the main steps were the same as those in Example 1. Example 3 differed from Example 1 in that the current density was 114.28 mA/cm² and the reaction time was 5 h.

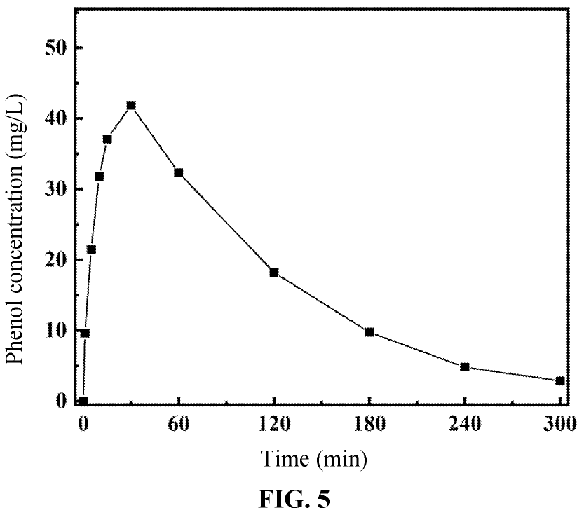

Treatment effect: the activated carbon fiber had a regeneration ratio of 69.66%. As can be seen from FIG. 5, the phenol concentration in the solution after 5 h of regeneration is 2.88 mg/L in this example, and the phenol removal ratio is 99% calculated according to formula (1).

### Example 4

An electrochemical regeneration method of saturated activated carbon was provided; and the main steps were the same as those in Example 1. Example 4 differed from Example 1 in that the current density was 57.14 mA/cm².

Treatment effect: the activated carbon had a regeneration ratio of 77.85%. 5 h after regeneration, the phenol concentration was 2.90 mg/L, and the removal ratio of phenol was 99% calculated according to formula (1).

### Example 5

An electrochemical regeneration method of saturated activated carbon was provided; and the main steps were the same as those in Example 1. Example 5 differed from Example 1 in that the current density was 17.14 mA/cm².

Treatment effect: the activated carbon had a regeneration ratio of 61.27%. 5 h after regeneration, the phenol concentration was 11.23 mg/L, and the removal ratio of phenol was 95% calculated according to formula (1).

### Example 6

An electrochemical regeneration method of saturated activated carbon was provided; and the main steps were the same as those in Example 1. Example 6 differed from Example 1 in that potassium peroxymonosulfate had a concentration of 27 g/L.

Treatment effect: the activated carbon had a regeneration ratio of 70.02%. 5 h after regeneration, the phenol concentration was 4.08 mg/L, and the removal ratio of phenol was 98% calculated according to formula (1).

### Example 7

An electrochemical regeneration method of saturated activated carbon was provided; and the main steps were the same as those in Example 1. Example 7 differed from Example 1 in that potassium peroxymonosulfate had a concentration of 9 g/L.

Treatment effect: the activated carbon had a regeneration ratio of 65.96%. 5 h after regeneration, the phenol concentration was 7.4 mg/L, and the removal ratio of phenol was 97% calculated according to formula (1).

### Example 8

An electrochemical regeneration method of saturated activated carbon was provided; and the main steps were the same as those in Example 1. Example 8 differed from Example 1 in that hydrogen peroxide was added at a rate of 0.6 mL/h in the first 40 min, and then added at a rate of 0.3 mL/h in the later 260 min.

Treatment effect: the activated carbon had a regeneration ratio of 71.32%. 5 h after regeneration, the phenol concentration was 6.18 mg/L, and the removal ratio of phenol was 97% calculated according to formula (1).

### Comparative Example 1

An electrochemical regeneration method of saturated activated carbon was provided; and the main steps were the same as those in Example 1. Comparative Example 1 differed from Example 1 in that no hydrogen peroxide solution was added.

Treatment effect: the activated carbon fiber had a regeneration ratio of 62.08%. 5 h after regeneration, the phenol concentration was 9.05 mg/L, and the removal ratio of phenol was 96% calculated according to formula (1). 5 h after regeneration, the TOC concentration in the solution was 21.67 mg/L, and the mineralization ratio of organic compound was 85% calculated according to formula (2).

### Comparative Example 2

An electrochemical regeneration method of saturated activated carbon was provided; and the main steps were the same as those in Example 1. Comparative Example 2 differed from Example 1 in that potassium peroxymonosulfate was replaced with sodium chloride having a concentration of 2.93 g/L, and no hydrogen peroxide solution was added.

Treatment effect: the activated carbon fiber had a regeneration ratio of 62.54%. 5 h after regeneration, the phenol concentration was 42.63 mg/L, and the removal ratio of phenol was 80% calculated according to formula (1). 5 h after regeneration, the TOC concentration in the solution was 137.6 mg/L, and the mineralization ratio of organic compound was 20% calculated according to formula (2).

Energy consumption in Example 1 and Comparatives 1 and 2 was calculated according to formula (3), as shown in Table 1:

$${E}_{EO} = \frac{Pt}{V \times 60 \times lg ( \frac{{C}_{0}}{{C}_{t}} )} = \frac{Pt}{60 \times 0.4 \; 343 Vkt} = \frac{P}{26 Vk} \qquad ( 3 )$$

where, P is a direct-current power (W) of a power system, t is regeneration time (h), V is a regeneration solution volume (L), C₀ is an initial concentration of TOC, Cₜ is a concentration of TOC at t min, and K is a first order rate constant (min⁻¹) of pollutant removal.

TABLE 1
Comparison of energy consumption

| | Current | | | | Regeneration | |
|---|---|---|---|---|---|---|
| Regeneration | density (mA | Voltage | Power | K (10⁻²) | solution volume | E_{EO} |
| system | cm⁻²) | U (v) | (w) | (min⁻¹) | (L) | (KWh · m⁻³) |
| Example 1 | 28.57 | 3.52 | 1.76 | 1.244 | 0.25 | 0.218 |
| (E-PMS-H₂O₂) | | | | | | |
| Comparative | 28.57 | 4.85 | 2.43 | 0.936 | 0.25 | 0.399 |
| Example 1 | | | | | | |
| (E-PMS) | | | | | | |
| Comparative | 28.57 | 6.28 | 3.14 | 0.237 | 0.25 | 2.04 |
| Example 2 (E) | | | | | | |

As can be seen from Table 1, during the regeneration of activated carbon, compared with the separate electrolysis system and composite electrochemical persulfate system, the present disclosure has lower energy consumption and lower costs in the treatment of activated carbon adsorbing same amount of organic compounds.

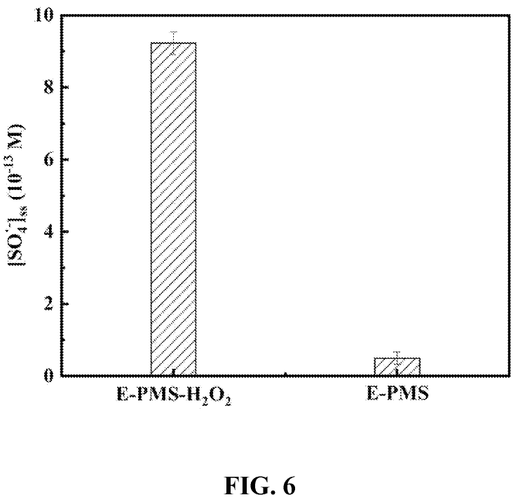

Moreover, as shown in FIG. 6, the electrochemical/persulfate/hydrogen peroxide system of the present disclosure has a SO₄·⁻ yield 18.2 times of the electrochemical-persulfate system in Comparative Example 1, and the amount of SO₄·⁻ is in direct proportion to its degradation and mineralization ability to organic compounds. Therefore, the present disclosure may maximize degrade and mineralize organic compounds, and reduce the input of agents and save costs at the same time.

It should be noted that the above examples are only intended to explain, rather than to limit the technical solutions of the present disclosure. Those of ordinary skill in the art should understand that modifications or equivalent substitutions may be made to the technical solutions of the present disclosure without departing from the spirit and scope of the technical solutions of the present disclosure, and such modifications or equivalent substitutions should be included within the scope of the claims of the present disclosure.

What is claimed is:

1. An electrochemical regeneration method of activated carbon, comprising placing activated carbon saturated with an organic compound into an electrolysis system containing a regeneration solution to serve as a cathode of the electrolysis system, adding a peroxide I and a peroxide II to the regeneration solution, connecting to power and conducting a reaction, and continuously adding the peroxide II dropwise during the reaction, and after the reaction is completed, taking out and drying the activated carbon to obtain regenerated activated carbon, wherein the peroxide I is a persulfate.

2. The electrochemical regeneration method of activated carbon according to claim 1, wherein the electrolysis system has an operating current density of 10-120 mA/cm².

3. The electrochemical regeneration method of activated carbon according to claim 1, wherein a mass ratio of the activated carbon, the persulfate, and the peroxide II is 1:(5-50):(5-50).

4. The electrochemical regeneration method of activated carbon according to claim 1, wherein the peroxide II is hydrogen peroxide.

5. The electrochemical regeneration method of activated carbon according to claim 1, wherein the organic compound is one or more selected from the group consisting of a halogenated organic compound, phenol, an antibiotic, and an endocrine disruptor.

6. The electrochemical regeneration method of activated carbon according to claim 1, wherein the peroxide II is continuously added by stages at different rates.

7. The electrochemical regeneration method of activated carbon according to claim 1, wherein in the electrolysis system, the cathode is selected from the group consisting of a metal electrode and a composite metal electrode, and used as a supporting layer for placing the activated carbon to be regenerated: an anode is selected from the group consisting of a metal electrode, a metal oxide electrode, a graphite electrode, and a composite metal electrode.

8. The electrochemical regeneration method of activated carbon according to claim 1, wherein the activated carbon is selected from the group consisting of a powdered activated carbon, a granular activated carbon, an activated carbon fiber, a carbon felt, a carbon nano tube, and a graphene.

9. The electrochemical regeneration method of activated carbon according to claim 3, wherein the mass ratio of the activated carbon, the persulfate, and the peroxide II is 1:(10-40):(10-45).

10. The electrochemical regeneration method of activated carbon according to claim 6, wherein the peroxide II is added faster in the first 0.5-1 h than in a remaining reaction time.
